(19) United States
(12) Patent Application Publication
(10) Pub. No.: US 2018/0359211 A1
(43) Pub. Date: Dec. 13, 2018

(54) SYSTEMS AND METHODS FOR A COMMUNICATION SYSTEM

(71) Applicant: Walmart Apollo, LLC, Bentonville, AR (US)

(72) Inventors: Kevin Matthew Charles, Bentonville, AR (US); Jonathan Alexander Huckvale, Rogers, AR (US); Richard Talmadge Jackson, JR., Bella Vista, AR (US); Michael John Karagines, Brooksville, FL (US); John R. Frerking, Prairie Grove, AR (US)

(21) Appl. No.: 16/002,389

(22) Filed: Jun. 7, 2018

Related U.S. Application Data
(60) Provisional application No. 62/517,560, filed on Jun. 9, 2017.

(51) Int. Cl. H04L 12/58

(52) U.S. Cl. CPC H04L 51/36; H04W 4/14; H04L 51/24

(57) ABSTRACT

Systems, methods, and machine readable medium are provided for communicating between disparate applications. Exemplary embodiments create an email provisioning service and an SMS message provisioning service based on provisioning data received from a user device to provision communications to multiple disparate applications. An indication to initiate the communication service is received from the user device. One or both of the email provisioning service or the SMS provisioning service is selected and executed to send an email message or an SMS message to the multiple disparate applications. Exemplary embodiments include transmitting an alert to the user device indicating failure or success of the execution of the provisioning services, and tracking a number of times the indication is received from the user device to initiate user of the communication service.

### RELATED APPLICATION

This application claims priority to U.S. Provisional Application No. 62/517,560 filed on Jun. 9, 2017, the contents of which is hereby incorporated by reference in its entirety.

### BACKGROUND

Users of many software applications may have a need to send communications to other applications, programs, users, entities, etc. The user may need to build custom interfaces and APIs to send communications via the software application and to develop customer interfaces and APIs.

### SUMMARY

In one embodiment, a method for communicating between disparate applications is provided. The method includes receiving provisioning data from a user device at a communication service to provision communications from the communication service to multiple disparate applications. The method further includes creating an email provisioning service based on the provisioning data to send an email message to the multiple disparate applications, creating an SMS message provisioning service based on the provisioning data to send an SMS message to the multiple disparate applications, and storing the email provisioning service and the SMS message provisioning service in the communication service. The method also includes receiving data from the user device that includes text and an indication to initiate the communication service. One of the email provisioning service or the SMS provisioning service is selected to execute based on analysis of the received data. The method includes executing the selected provisioning service in the communication service to send an email message or an SMS message with the text in the received data to the multiple disparate applications. The method further includes transmitting an alert to the user device indicating failure or success of the execution of the one or more provisioning services, and tracking a number of times data is received from the user device to initiate use of the communication service.

In another embodiment, a system for communication between disparate applications is provided. The system includes a provisioning module and a communication module. The provisioning module is configured to receive provisioning data from a user device at a communication service to provision communications from the communication service to multiple disparate applications, create an email provisioning service based on the provisioning data to send an email message to the multiple disparate applications, and create an SMS message provisioning service based on the provisioning data to send an SMS message to the multiple disparate applications. The provisioning module is further configured to store the email provisioning service and the SMS message provisioning service in the communication service. The communication module is configured to receive data from the user device including text and an indication to initiate the communication service. The communication module is configured to select one of the email provisioning service or the SMS message provisioning service to execute based on analysis of the received data, and execute the selected provisioning service in the communication service to send an email message or an SMS message with the text in the received data to the multiple disparate applications. The communication module is also configured to transmit an alert to the user device indicating failure or success of the execution of the one or more provisioning services, and track a number of times data is received from the user device to initiate use of the communication service.

In another embodiment, a non-transitory machine readable medium is provided to store instructions that when executed causes a processor to implement a method for communicating between disparate applications. The method includes receiving provisioning data from a user device at a communication service to provision communications from the communication service to multiple disparate applications. The method further includes creating an email provisioning service based on the provisioning data to send an email message to the multiple disparate applications, creating an SMS message provisioning service based on the provisioning data to send an SMS message to the multiple disparate applications, and storing the email provisioning service and the SMS message provisioning service in the communication service. The method also includes receiving data from the user device that includes text and an indication to initiate the communication service. One of the email provisioning service or the SMS provisioning service is selected to execute based on analysis of the received data. The method includes executing the selected provisioning service in the communication service to send an email message or an SMS message with the text in the received data to the multiple disparate applications. The method further includes transmitting an alert to the user device indicating failure or success of the execution of the one or more provisioning services, and tracking a number of times data is received from the user device to initiate use of the communication service.

### BRIEF DESCRIPTION OF THE DRAWINGS

The accompanying drawings, which are incorporated in and constitute a part of this specification, illustrate one or more embodiments of the invention and, together with the description, help to explain the invention. The embodiments are illustrated by way of example and should not be construed to limit the present disclosure. In the drawings:

FIG. 1 is a block diagram showing a communication system in terms of modules, according to an example embodiment;

FIG. 2 is a flowchart illustrating an exemplary method for communicating between disparate applications, according to an example embodiment;

FIG. 3 is a flowchart illustrating an exemplary method for provisioning the communication system, according to an example embodiment;

FIG. 4 is a flowchart illustrating an exemplary method of using the communication system, according to an example embodiment;

FIG. 5 illustrates an example architecture for the communication system, according to an example embodiment;

FIG. 6 is a diagram of an exemplary network environment suitable for a distributed implementation of exemplary embodiments; and

FIG. 7 is a block diagram of an exemplary computing device that may be used to implement exemplary embodiments described herein.

### DETAILED DESCRIPTION

Exemplary embodiments provide a communication system for sending communications to disparate applications. The communication system described herein is configured to include a standardized interface that can plug into a variety of backend systems and applications to send communications to different applications. The communication system can send various types of communications, including emails, SMS messages, and other digital communications. In an example embodiment, the communication system is a cloud-based notification system. The communication system also tracks use of the system by a user to determine the cost of use by a particular user. Each user may have his or her own URL link to access the communication system. In an example embodiment, the communication system described herein is a Notification-as-a-Service system.

By utilizing the communication system described herein, application developers no longer have to rely on custom-built notifications like email or SMS messages for their applications. Since the communication system described herein includes a standardized interface, an organization or entity can continue using the communication system even after switching the organization's or entity's backend system. For example, if an entity is configured to use a first email client today, but switches to using a second email client tomorrow, the communication system described herein can still work with the second email client. Also new communications can be added without significant changes to the communication system.

In an example embodiment, the communication system includes a custom-built Representational State Transfer (REST) interface that connects into the backend system components of emails, SMS messages, and other communication services. The custom-built features of the REST interface include, but are not limited to, features relating to service calls for the system described herein. The custom-built REST interface enables the communication system to integrate with a variety of other backend systems used by organizations and entities. The cloud-based architecture of the communication system provides separate provisioning endpoints for each user to accommodate for capacity.

As used herein, provisioning refers to the process of preparing and equipping the communication system to enable it to provide new communication services to its users. In an example embodiment, the communication system includes decoupled services and components, and during provisioning the decoupled services and components are provisioned, rather than provisioning the entire system. For example, the decoupled services and components include an email provisioning service and an SMS message provisioning service. The decoupled services and components enable the communication system described herein to provide services to a user, without the user needing access to the backend components or needing to provide hardware or software support for the backend components. A user can use the communication system via a user interface, regardless of the type software or hardware included in his or her client device. In an example embodiment, the communication system described herein is implemented in a cloud environment.

The user inputs information for provisioning the communication system via a user interface. The user may input information including, but not limited to, username, user type, size of communications needed, backend communication protocols to use, and the like. The communication system described creates a new endpoint and links it to the user. The communication system may also create a custom user interface for the user to access the communication system. The user interface may enable the user to log-in with his or her unique log-in information, update his or her preferences, request logs or reports from the system, and perform other tasks.

As used herein, disparate applications refer to applications that differ from one another in terms of at least one of interfaces, components, functionalities, etc., and are not compatible with one another. A first type of (disparate) application may require particular formats or communication protocols that are compatible with the first disparate application, but these formats or communication protocols may not be compatible with a second type of (disparate) application.

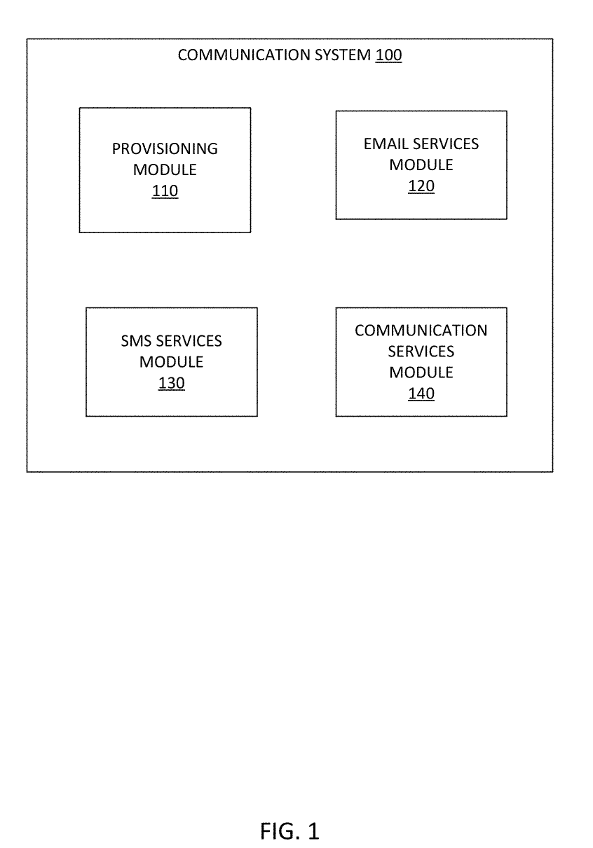

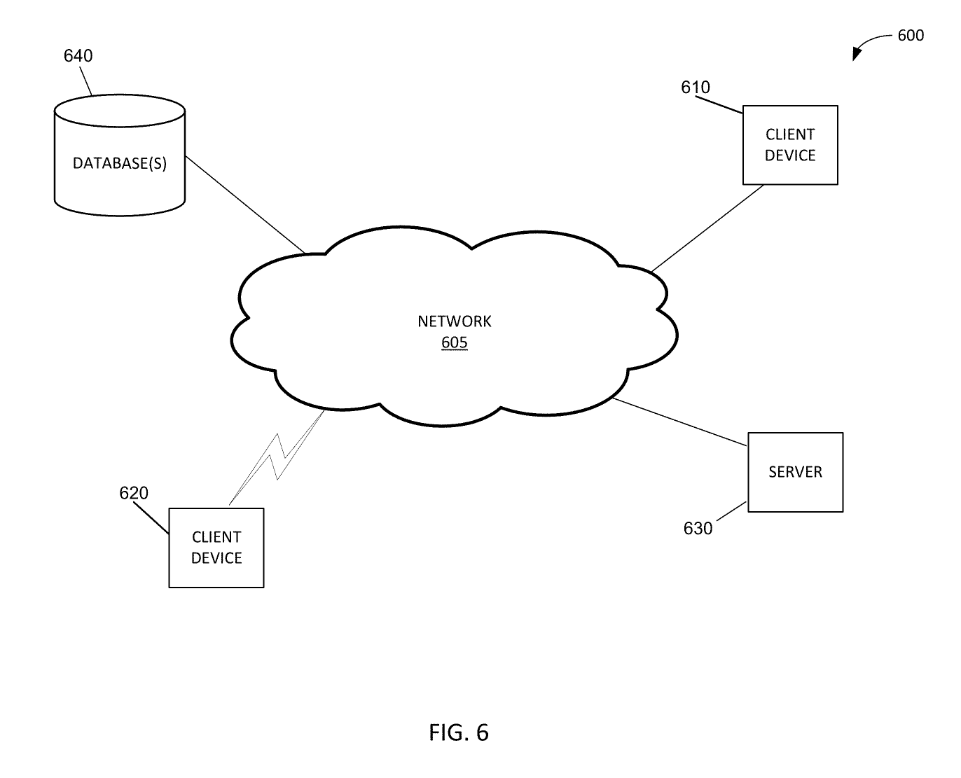

FIG. 1 is a block diagram 100 showing a communication system in terms of modules according to an example embodiment. One or more of the modules may be implemented using device 610, 620, server 630 and/or database 640 as shown in FIG. 6. The modules include a provisioning module 110, an email services module 120, an SMS services module 130, and a communication services module 140. The modules may include various circuits, circuitry and one or more software components, programs, applications, or other units of code base or instructions configured to be executed by one or more processors. In some embodiments, one or more of modules 110, 120, 130, 140 may be included in server 630, while other of the modules 110, 120, 130, 140 are provided in device 610 or 620. Although modules 110, 120, 130, and 140 are shown as distinct modules in FIG. 1, it should be understood that modules 110, 120, 130, and 140 may be implemented as fewer or more modules than illustrated. It should be understood that any of modules 110, 120, 130, and 140 may communicate with one or more components included in system 600 (FIG. 6), such as device 610, device 620, server 630, or database(s) 640.

The provisioning module 110 may be configured to receive, store and manage provisioning data from a user device to enable setup of the communication services provided by the communication system 100 described herein. The provisioning module 110 may be configured to analyze the provisioning data and forward the data to the appropriate module. In an example embodiment, the provisioning module 110 may be configured to generate a user interface for display on the user device, and to accept the user inputs of provisioning data via the user interface.

The email services module 120 may be configured to create email services based on the provisioning data provided by the user. The email services module 120 may be configured to prepare the communication system 100 to send email communications to disparate applications.

The SMS services module 130 may be configured to create SMS message services based on the provisioning data provided by the user. The SMS services module 130 may be configured to prepare the communication system 100 to send SMS message communications to disparate applications.

The communication services module 140 may be configured to store and manage provisioned services for email and SMS message communications. The communication services module 140 may be configured to prepare and send communications to disparate applications based on a user initiating the communication system 100. The communication services module 140 may be configured to execute the appropriate module to send email and SMS message communications. In some embodiments, the communication services module 140 generates and transmits an alert to the user device indicating whether one or more of the communication services failed or succeeded. The communication services module 140 may also track a number of times a user initiates use of the communication system 100.

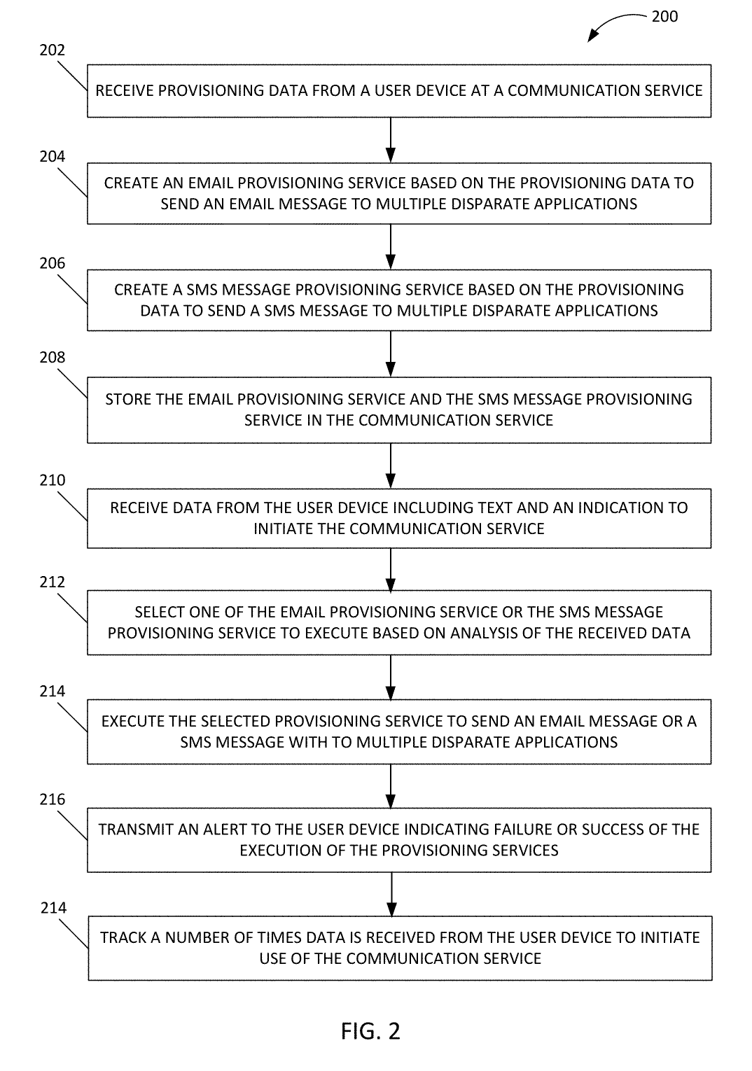

FIG. 2 is a flowchart illustrating an exemplary method for communicating between disparate applications, according to an example embodiment. The method 200 may be performed using or one or more modules of system 100 described above.

In some embodiments, a user creates a user profile via a user interface displayed at the user device. The communication system 100 stores data associated with the user from the user profile, such as username, password and the like. The communication system 100 also associates and stores the provisioning data provided by the user with the user profile, and associates and stores the provisioned services created by the communication system 100 with the user profile. When the user wants to initiate the communication system 100, he or she can log on to the system and the initiate communication services prepared based on the provisioning data. In an example embodiment, each user is provided with his or her own URL link to the communication system, which facilities tracking use of the communication system by each user.

At step 202, the provisioning module 110 receives provisioning data from a user device at a communication service to provision communications from the communication service to multiple disparate applications. In some embodiments, the provisioning data includes multiple email addresses that may be hosted via multiple disparate applications. In some embodiments, the provisioning data includes multiple phone numbers that may be associated with devices that operate using disparate applications or operating systems.

At step 204, the email services module 120 creates an email provisioning service based on the provisioning data to send an email message to multiple disparate applications. When the request for email communication services is received, the email services module 120 creates a new email endpoint using the provisioning data to call the email service. The new email endpoint is created to provide email communications regardless of the backend system implemented in the communication system 100.

At step 206, the SMS services module 130 creates an SMS message provisioning service based on the provisioning data to send an SMS message to multiple disparate applications. When the request for SMS communication services is received, the SMS services module 130 creates a new SMS endpoint using the provisioning data to call the SMS service. The new SMS endpoint is created to provide SMS communications regardless of the backend system implemented in the communication system 100.

At step 208, the communication services module 140 stores the email provisioning service and the SMS message provisioning service in the communication service. In an example embodiment, the communication system 100 transmits a confirmation message to the user device upon successfully creating and storing the email provisioning service and the SMS message provisioning service.

At step 210, the communication services module 140 receives data from the user device including text and an indication to initiate the communication service. The communication services module 140 generates a message based on the text in the data received from the user at step 210. In an example embodiment, the message is formatted such that it is deliverable to multiple disparate applications.

At step 212, the communication services module 140 selects one of the email provisioning service or the SMS provisioning service to execute based on analysis of the received data. The communication services module 140 may determine that the email provisioning service is to be executed based on analysis of the received data, and selects the email provisioning service for execution. Alternatively, the communications services module 140 may determine that the SMS provisioning service is to be executed based on analysis of the received data, and selects the SMS provisioning service for execution. In an example embodiment, the communication services module 140 selects both of the email provisioning service and the SMS provisioning service for execution.

At step 214, the communication services module 140 executes the selected provisioning service to send an email message or an SMS message to multiple disparate applications. If the email provisioning service is selected, then the communication services module 140 executes the stored email provisioning service by transmitting an email message to multiple disparate applications. The communication services module 140 may cause the email services module 120 to execute the stored email provisioning service. Execution of the stored email provisioning service may include transmitting an email message to the email addresses provided by the user in the provisioning data.

If the SMS provisioning service is selected, then the communication services module 140 executes the stored SMS provisioning service by transmitting an SMS message to multiple disparate applications. The communication services module 140 may cause the SMS services module 130 to execute the stored SMS provisioning service. Execution of the stored SMS provisioning service may include transmitting an SMS message to the phone numbers provided by the user in the provisioning data.

At step 216, the communication services module 140 transmits an alert to the user device indicating failure or success of the execution of the provisioning services. One or more email addresses or phone numbers may fail to receive the communications transmitted by the communication system 100. For example, an email address or phone number may be incorrect or deactivated, or may be configured to not receive messages from commercial communication systems. In this case, the communication system may receive a message returned notification. If the message is received by the destination email addresses or the phone numbers, then the communication system may receive a message successful notification. The alert transmitted by the communication services module 140 may indicate which email addresses and phone numbers successfully received the message, and which email addresses and phone numbers failed to receive the message. In an example embodiment, the communication system 100 is configured to run a process to check that all the endpoints are provisioned correctly and run without errors. The process can be customized to run at specified time intervals, for example, the process can be configured to run once a minute, once an hour, once a day, etc.

When the provisioned endpoint is created, the communication system calls or executes the endpoint including all of the necessary service calls for the endpoint. The communication system calls the created endpoints with the provisioning data provided by the user to ensure they execute successfully. When the user initiates the communication system to send communications, the endpoint and user information is linked to the transaction on the backend of the communication system to ensure the correct user information is being sent as communications. In an example embodiment, the communication system includes daemon processes that run on the backend to gather metrics and information related to the service calls executed in response to the user initiating the communication system.

At step 218, the communication services module 140 tracks a number of times data is received from the user device to initiate use of the communication service.

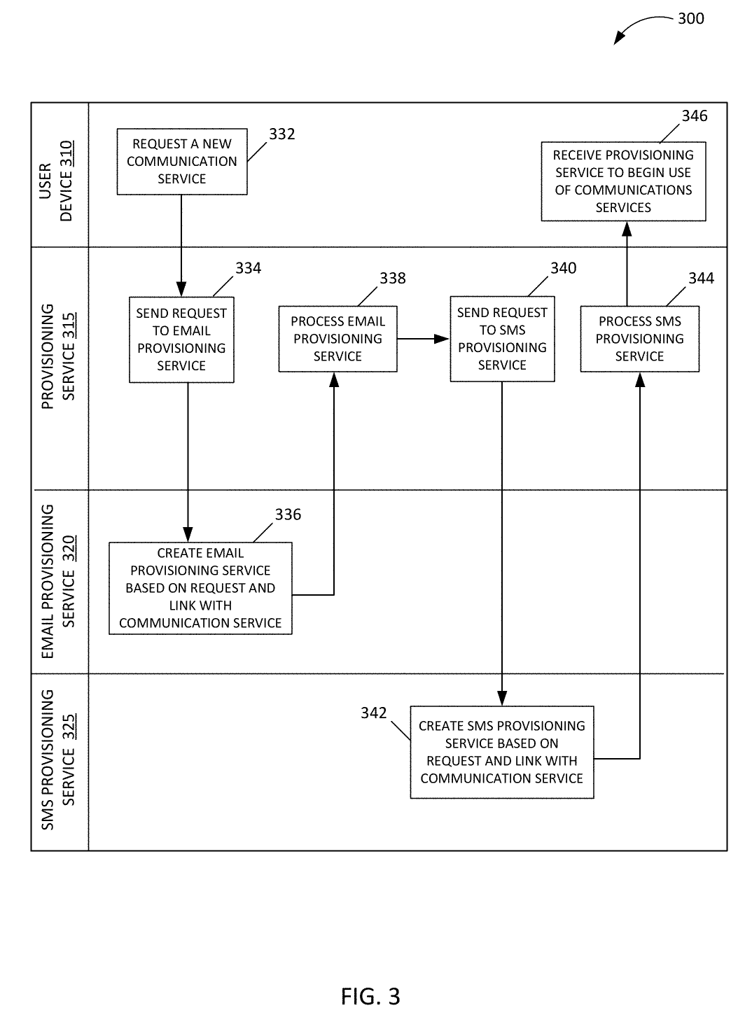

FIG. 3 is a flowchart illustrating an exemplary method 300 for provisioning the communication system, according to an example embodiment. The communication system may include a user device 310, a provisioning service 315 at a server (e.g., server 630), an email provisioning service 320 at the server (e.g., server 630), and SMS provisioning service 325 at the server (e.g., server 630).

The user device 320 transmits a request for a new communication service to the communication system (block 332). The request includes provisioning data from the user to prepare the communication system to send communications to various disparate applications. At block 334, the provisioning service 315 forwards the request to the email provisioning service 320.

The email provisioning service 320 creates email provisioning services based on the request and data included in the request (block 336). The email provisioning services 320 links the created email provisioning service with the communication service. At block 338, the provisioning service 315 processes the email provisioning service. When the user submits his or her request for an email endpoint, a REST service call is executed at the communication system 100 to create the necessary table space, provisioning identifiers, log information, etc. Once that is created, the email service details are communicated in a REST response to the client device that made the request.

At block 340, the provisioning service 315 forwards the request to the SMS provisioning service 325. The SMS provisioning service 325 creates SMS provisioning services based on the request and data included in the request (block 342). The SMS provisioning services 325 links the created SMS provisioning service with the communication service. At block 344, the provisioning service 315 processes the SMS provisioning service. When the user submits his or her request for an SMS endpoint, a REST service call is executed at the communication system 100 to create the necessary table space, provisioning identifiers, log information, etc. Once that is created, the email service details are communicated in a REST response to the client device that made the request.

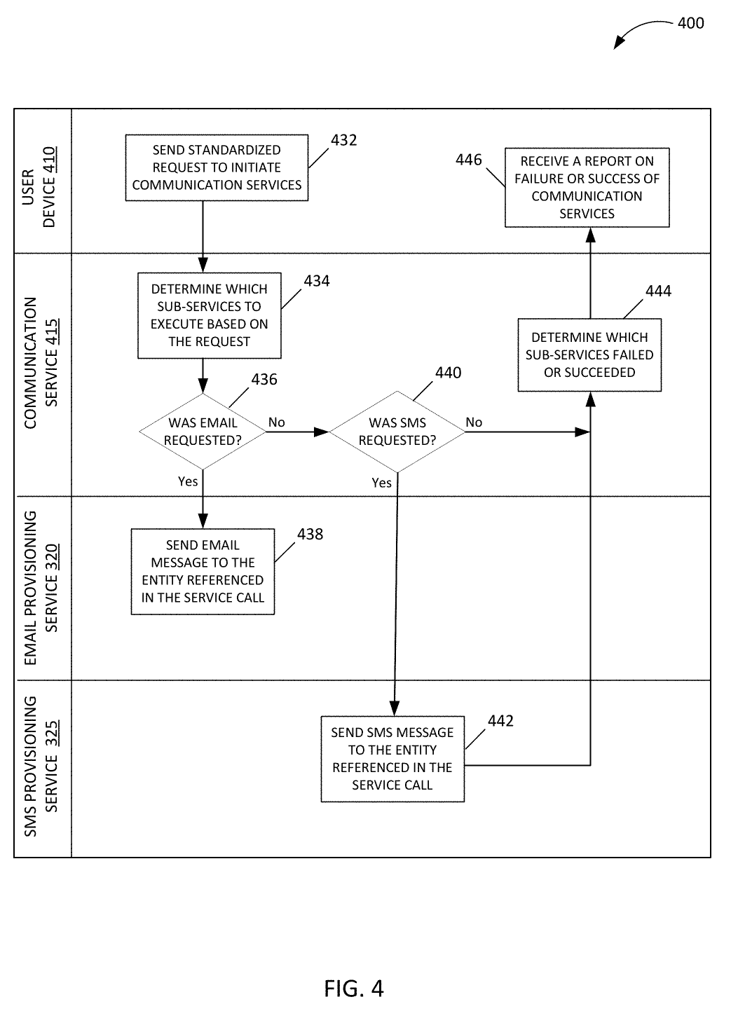

FIG. 4 is a flowchart illustrating an exemplary method 400 of using the communication system, according to an example embodiment. The communication system includes a user device 410, a communication service 415 at a server (e.g. server 630), the email provisioning service 320 described above, and the SMS provisioning service 325 described above.

The user device 410 transmits a standardized request to the communication service 415 to initiate communication services (block 432). The system includes a standardized interface (for example, a REST interface/service) that client devices including different types of software and hardware can use. The request is translated at the backend to be used for each email, SMS or other endpoints. As such, if the backend system changes for email or SMS communications, the client device does not require updating or changes. The communication service 415 determines which sub-services to execute based on the request received from the user device 410 (block 434). Sub-services include email communication services as provisioned by the email provisioning service 320 and SMS message services as provisioned by the SMS provisioning service 325. At block 436, the communication service 415 determines if email communication services are requested at block 432. If email communication services are requested, then the communication service 415 executes the email provisioning service 320. At block 438, the email provisioning service prepares and sends one or more email messages to the entity referenced in the service call. A service call to the email provisioning service 320 is triggered by the communication service 415 in response to determining that the request to initiate communication services requested email communication services. The request at block 432 includes text, data, images, etc. to be included in the communications sent to the disparate applications. The email provisioning service 320 prepares a message based on the text, data or images included in the request, and sends the message to the email addresses provided by the user during provisioning of the communication system. The user provisions the communication system according to method 300 of FIG. 3.

From block 438, the method continues to block 440. If email communication services are not requested, as determined at block 436 by the communication service 415, then the method also continues to block 440. At block 440, the communication service 415 determines if SMS message services are requested. If SMS message services are requested, then the communication service 415 executes the SMS provisioning service 325. At block 442, the SMS provisioning service prepares and sends one or more SMS messages to the entity referenced in the service call. A service call to the SMS provisioning service 325 is triggered by the communication service 415 in response to determining that the request to initiate communication services requested SMS message services. The request at block 432 includes text, data, images, etc. to be included in the communications sent to the disparate applications. The SMS provisioning service 325 prepares an SMS message based on the text, data or images included in the request, and sends the SMS message to the phone numbers provided by the user during provisioning of the communication system. The user provisions the communication system according to method 300 of FIG. 3.

From block 442, the method continues to block 444. If SMS message services are not requested, as determined at block 440 by the communication service 415, then the method also continues to block 444. At block 444, the communication service 415 determines which, if any, sub-services failed or succeeded. One or more email addresses or phone numbers may fail to receive the communications transmitted by the communication system. For example, an email address or phone number may be incorrect or deactivated, or may be configured to not receive messages from commercial communication systems. In this case, the communication system may receive a message returned notification. If the message is received by the destination email addresses or the phone numbers, then the communication system may receive a message successful notification. At block 446, the user device receives a report on failure or success of the communication services as determined at block 444. The report may indicate which email addresses and phone numbers successfully received the message, and which email addresses and phone numbers fails to receive the message.

In an example embodiment, a user can request to provision multiple services, for example email communication services and SMS communication services. When initiating use of the communication system 100, the user may specify which provisioned service to execute. For example, the user may select to execute the email communication services only.

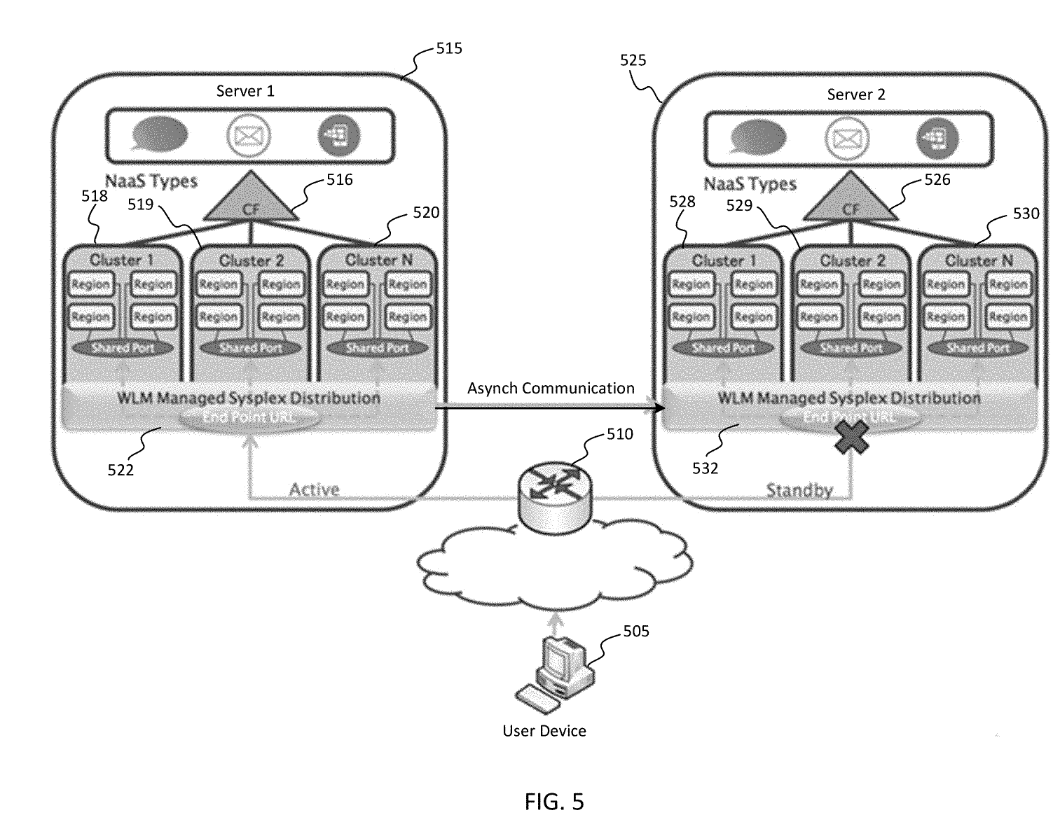

FIG. 5 illustrates an example architecture for the communication system, according to an example embodiment. A user accesses the communication system via the user device 505 and by using a personalized URL link. The architecture for the communication system includes a workload manager 510, server 515 and server 525. Server 525 may be a backup server. Servers 515 and 525 may be virtual servers. Servers 515 and 525 includes components that facilitate operation of the communication system. For example, the server 515 includes a coupling facility 516 for clusters 518, 519, and 520. Server 525 includes a coupling facility 526 for clusters 528, 529, and 530. Each of server 515 and 525 may include fewer or more than three clusters. A cluster refers to a group of computing devices connected by a local area network (LAN).

Each of server 515 and 525 provide two client ports, one SSL and one non-SSL. Server 525, acting as the backup server, keeps the two client ports closed, unless the active server 515 becomes unavailable. When the active server 515 becomes unavailable, the backup server 525 automatically opens its ports and takes on the full workload.

Server 515 also includes a sysplex distributor 522 and server 525 includes a sysplex distributor 532. The workload manager 510 and the sysplex distributors 522 perform workload management by automatically distributing requests for workload among the clusters 518, 519 and 520. Similarly, the workload manager 510 and the sysplex distributors 532 perform workload management by automatically distributing requests for workload among the clusters 528, 529, and 530.

In a non-limiting example, a user may want to use the communication system described herein for marketing purposes. The user may want to provision his or her own email service to send out marketing emails when a new campaign goes live, and may want to market to specific customers. The user may want to send an email to all customers that belong to that campaign. Instead of interfacing with different types of communication and software protocols for different email services, the user can use the communication system described herein that translates the communications on the backend to deliver to different types of email services.

In another non-limiting example, users (e.g. an account managers) can use the communication system described herein to transmit communications to its customers without developing or building their own infrastructure that is capable of communicating with disparate applications. As another example, users can use the communication system described herein to send ‘reminder’ messages in the form of texts, emails, messages or other notifications to disparate applications. In another example, cellular phone network and service providers may use the communication system described herein to transmit messages to its customers without needing to update and test their own infrastructure.

FIG. 6 illustrates a network diagram depicting a system 600 for implementing the communication system, according to an example embodiment. The system 600 can include a network 605, multiple client devices, for example, client device 610, client device 620, server 630, and a database(s) 640. Each of the client devices 610, 620, server 630, and database(s) 640 is in communication with the network 605.

In an example embodiment, one or more portions of network 605 may be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

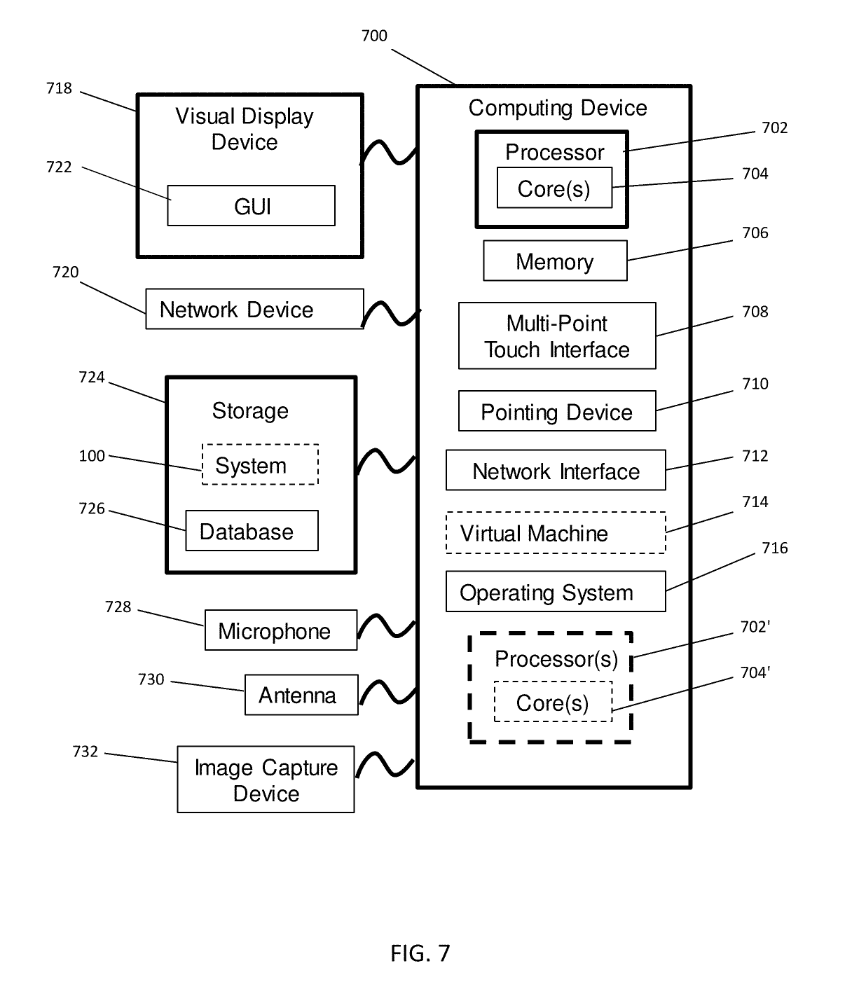

The devices 610, 620 may comprise, but are not limited to, work stations, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, network PCs, mini-computers, and the like. Each of devices 610, 620 may connect to network 605 via a wired or wireless connection. In an example embodiment, the devices 610, 620 may perform one or more of the functionalities of the notification system 100 described herein. The device 610, 620 can include one or more components of computing device 700 of FIG. 7. The device 610, 620 may be user devices via which the user can provision and use the communication system.

In an example embodiment, the communication system 100 may be included on the server 630, and the server 630 performs one or more of the functionalities of the communication system 100 described herein. In some embodiments, the devices 610, 620 may perform some of the functionalities, and the server 630 performs the other functionalities described herein. For example, the server 630 may cause the client device 610, 620 to generate the user interface for the communication system and receive provisioning data and other data via the user interface. While server 630 provisions the email communication services and the SMS communication services, and sends communications to disparate applications.

Each of the database(s) 640, and server 630 is connected to the network 605 via a wired connection. Alternatively, one or more of the database(s) 640, and server 630 may be connected to the network 605 via a wireless connection. Server 630 comprise one or more computers or processors configured to communicate with client devices 610, 620 via network 605. The server 630 can include one or more components of device 700 of FIG. 7. Server 630 hosts one or more applications or websites, including the communication system described herein, accessed by client devices 610, 620 and/or facilitates access to the content of database(s) 640. Database(s) 640 comprise one or more storage devices for storing data and/or instructions (or code) for use by server 630, and/or client devices 610, 620. Database(s) 640 and server 630 may be located at one or more geographically distributed locations from each other or from client devices 610, 620. Alternatively, database(s) 640 may be included within server 630.

FIG. 7 is a block diagram of an exemplary computing device 700 that can be used to perform one or more steps of the methods provided by exemplary embodiments. For example, computing device 700 may be, but is not limited to client device 610, 620 and server 630 as described in FIG. 6 or server 515, 525 as described in FIG. 5. The computing device 700 includes one or more non-transitory computer-readable media for storing one or more computer-executable instructions or software for implementing exemplary embodiments. The non-transitory computer-readable media can include, but are not limited to, one or more types of hardware memory, non-transitory tangible media (for example, one or more magnetic storage disks, one or more optical disks, one or more USB flashdrives), and the like. For example, memory 706 included in the computing device 700 can store computer-readable and computer-executable instructions or software for implementing exemplary embodiments. The computing device 700 also includes processor 702 and associated core 704, and optionally, one or more additional processor(s) 702′ and associated core(s) 704′ (for example, in the case of computer systems having multiple processors/cores), for executing computer-readable and computer-executable instructions or software stored in the memory 706 and other programs for controlling system hardware. Processor 702 and processor(s) 702′ can each be a single core processor or multiple core (704 and 704′) processor.

Virtualization can be employed in the computing device 700 so that infrastructure and resources in the computing device can be shared dynamically. A virtual machine 714 can be provided to handle a process running on multiple processors so that the process appears to be using only one computing resource rather than multiple computing resources. Multiple virtual machines can also be used with one processor.

Memory 706 can include a computer system memory or random access memory, such as DRAM, SRAM, EDO RAM, and the like. Memory 706 can include other types of memory as well, or combinations thereof. A user can interact with the computing device 700 through a visual display device 718, such as a touch screen display or computer monitor, which can display one or more user interfaces 719. The visual display device 718 can also display other aspects, elements and/or information or data associated with exemplary embodiments. The computing device 700 can include other I/O devices for receiving input from a user, for example, a keyboard or any suitable multi-point touch interface 708, a pointing device 710 (e.g., a pen, stylus, mouse, or trackpad). The keyboard 708 and the pointing device 710 can be coupled to the visual display device 718. The computing device 700 can include other suitable conventional I/O peripherals.

The computing device 700 can also include one or more storage devices 724, such as a hard-drive, CD-ROM, or other computer readable media, for storing data and computer-readable instructions and/or software, such as one or more modules of the system 100 shown in FIG. 1 that implements exemplary embodiments of the notification system as described herein, or portions thereof, which can be executed to generate user interface 719 on display 718. Exemplary storage device 724 can also store one or more databases for storing any suitable information required to implement exemplary embodiments. The databases can be updated by a user or automatically at any suitable time to add, delete or update one or more items in the databases. Exemplary storage device 724 can store one or more databases 726 for storing provisioned data, and other data/information used to implement exemplary embodiments of the systems and methods described herein.

The computing device 700 can include a network interface 712 configured to interface via one or more network devices 722 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 712 can include a built-in network adapter, network interface card, PCMCIA network card, card bus network adapter, wireless network adapter, USB network adapter, modem or any other device suitable for interfacing the computing device 700 to any type of network capable of communication and performing the operations described herein. Moreover, the computing device 700 can be any computer system, such as a workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

The computing device 700 can run any operating system 716, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, any operating systems for mobile computing devices, or any other operating system capable of running on the computing device and performing the operations described herein. In exemplary embodiments, the operating system 716 can be run in native mode or emulated mode. In an exemplary embodiment, the operating system 716 can be run on one or more cloud machine instances.

The following description is presented to enable any person skilled in the art to create and use a computer system configuration and related method and systems for sending communications to multiple disparate applications. Various modifications to the example embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present disclosure is not intended to be limited to the embodiments shown, but is to be accorded the widest scope consistent with the principles and features disclosed herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps can be replaced with a single element, component or step. Likewise, a single element, component or step can be replaced with a plurality of elements, components or steps that serve the same purpose. Moreover, while exemplary embodiments have been shown and described with references to particular embodiments thereof, those of ordinary skill in the art will understand that various substitutions and alterations in form and detail can be made therein without departing from the scope of the invention. Further still, other aspects, functions and advantages are also within the scope of the invention.

Exemplary flowcharts are provided herein for illustrative purposes and are non-limiting examples of methods. One of ordinary skill in the art will recognize that exemplary methods can include more or fewer steps than those illustrated in the exemplary flowcharts, and that the steps in the exemplary flowcharts can be performed in a different order than the order shown in the illustrative flowcharts.

What is claimed is:

1. A method for communicating between disparate applications, the method comprising:
receiving provisioning data from a user device at a communication service to provision communications from the communication service to a plurality of disparate applications;
creating an email provisioning service based on the provisioning data to send an email message to the plurality of disparate applications;
creating an SMS message provisioning service based on the provisioning data to send an SMS message to the plurality of disparate applications;
storing the email provisioning service and the SMS message provisioning service in the communication service;
receiving data from the user device including text and an indication to initiate the communication service;
selecting one of the email provisioning service or the SMS provisioning service to execute based on analysis of the received data;
executing the selected provisioning service in the communication service to send an email message or an SMS message with the text from the received data to the plurality of disparate applications;
transmitting an alert to the user device indicating failure or success of the execution of the one or more provisioning services; and
tracking a number of times data is received from the user device to initiate use of the communication service.

2. The method of claim 1, further comprising:
transmitting a confirmation message to the user device on successful storing of the email provisioning service and the SMS message provisioning service.

3. The method of claim 1, further comprising:
determining that the email provisioning service is to be executed based on analysis of the received data; and
executing the stored email provisioning service by transmitting an email message to the plurality of disparate applications.

4. The method of claim 3, wherein the provisioning data includes a plurality of email addresses hosted via the plurality of disparate applications, and executing the stored email provisioning service includes transmitting an email message to the plurality of email addresses.

5. The method of claim 1, further comprising:
determining that the text provisioning service is to be executed based on analysis of the received data; and
executing the stored text provisioning service by transmitting an SMS message to the plurality of disparate applications.

6. The method of claim 5, wherein the provisioning data includes a plurality of phone numbers and executing the stored text provisioning service includes transmitting an SMS message to the plurality of phone numbers.

7. The method of claim 6, wherein a first phone number of the plurality of phone numbers is associated with a mobile device executing a first disparate application and a second phone number of the plurality of phone numbers is associated with a mobile device executing a second disparate application.

8. The method of claim 1, further comprising:
generating, at the communication service, a message based on the text in the received data, the message being deliverable to the plurality of disparate applications.

9. The method of claim 1, wherein the communication service is a Notification-as-a-Service system.

10. A system for communication between disparate applications, the system comprising:
a provisioning module configured to:
receive provisioning data from a user device at a communication service to provision communications from the communication service to a plurality of disparate applications;
create an email provisioning service based on the provisioning data to send an email message to the plurality of disparate applications;
create an SMS message provisioning service based on the provisioning data to send an SMS message to the plurality of disparate applications; and
store the email provisioning service and the SMS message provisioning service in the communication service; and
a communication module configured to:
receive data from the user device including text and an indication to initiate the communication service;
select one of the email provisioning service or the SMS message provisioning service to execute based on analysis of the received data;
execute the selected provisioning service in the communication service to send an email message or an SMS message with the text from the received data to the plurality of disparate applications;
transmit an alert to the user device indicating failure or success of the execution of the one or more provisioning services; and
track a number of times data is received from the user device to initiate use of the communication service.

11. The system of claim 10, wherein the provisioning module is configured to transmit a confirmation message to the user device on successful storing of the email provisioning service and the SMS message provisioning service.

12. The system of claim 10, wherein the communication module is configured to:
determine that the email provisioning service is to be executed based on analysis of the received data; and
execute the stored email provisioning service by transmitting an email message to the plurality of disparate applications.

13. The system of claim 10, wherein the provisioning data includes a plurality of email addresses hosted via the plurality of disparate applications, and executing the stored email provisioning service includes transmitting an email message to the plurality of email addresses.

14. The system of claim 10, wherein the communication module is configured to:
determine that the text provisioning service is to be executed based on analysis of the received data; and
execute the stored text provisioning service by transmitting an SMS message to the plurality of disparate applications.

15. The system of claim 14, wherein the provisioning data includes a plurality of phone numbers and executing the stored text provisioning service includes transmitting an SMS message to the plurality of phone numbers.

16. The system of claim 15, wherein a first phone number of the plurality of phone numbers is associated with a mobile device executing a first disparate application and a second phone number of the plurality of phone numbers is associated with a mobile device executing a second disparate application.

17. The system of claim 10, wherein the communication module is configured to:
generate a message based on the text in the received data, the message being deliverable to the plurality of disparate applications.

18. The system of claim 10, wherein the communication service is a Notification-as-a-Service system.

19. A non-transitory machine readable medium storing instructions that when executed causes a processor to implement a method for communicating between disparate applications, the method comprising:
receiving provisioning data from a user device at a communication service to provision communications from the communication service to a plurality of disparate applications;
creating an email provisioning service based on the provisioning data to send an email message to the plurality of disparate applications;
creating an SMS message provisioning service based on the provisioning data to send an SMS message to the plurality of disparate applications;
storing the email provisioning service and the SMS message provisioning service in the communication service;
receiving data from the user device including text and an indication to initiate the communication service;
selecting one of the email provisioning service or the SMS message provisioning service to execute based on analysis of the received data;
executing the selected provisioning service in the communication service to send an email message or an SMS message with the text from the received data to the plurality of disparate applications;
transmitting an alert to the user device indicating failure or success of the execution of the one or more provisioning services; and
tracking a number of times data is received from the user device to initiate use of the communication service.

20. The non-transitory machine readable medium of claim 19, wherein the method further includes generating, at the communication service, a message based on the text in the received data, the message being deliverable to the plurality of disparate applications.
